(19) United States
(12) Patent Application Publication
(10) Pub. No.: US 2020/0097024 A1
(43) Pub. Date: Mar. 26, 2020

(54) METHOD AND APPARATUS FOR PROVIDING FLIGHT INFORMATION

(71) Applicant: LG Electronics Inc., Seoul (KR)

(72) Inventor: Namseok KIM, Seoul (KR)

(21) Appl. No.: 16/696,410

(22) Filed: Nov. 26, 2019

(30) Foreign Application Priority Data
Oct. 21, 2019 (KR) 10-2019-0130646

(51) Int. Cl. G05D 1/04; G08G 5/00; G05D 1/00; G06F 17/16

(52) U.S. Cl. CPC G05D 1/042; G08G 5/0008; G06F 17/16; G05D 1/0088; G08G 5/0021

(57) ABSTRACT

Disclosed is a method for providing information, including: identifying location information of the electronic device, displaying a three-dimensional map associated with a location of the electronic device and comprising auxiliary lines corresponding to three-dimensional coordinates, receiving, from another electronic device, a first message comprising location information of the another electronic device; and display information on the another electronic device on the three-dimensional based on the first message and the auxiliary lines, and at least one of the location information of the electronic device or the location information of the another electronic device comprises coordinate information of a matrix corresponding to a three-dimensional space.

### CROSS-REFERENCE TO RELATED APPLICATION

This application claims the benefit of Korean Patent Application No. 10-2019-0130646, filed on Oct. 21, 2019, the disclosure of which is incorporated herein in its entirety by reference.

### BACKGROUND

The present disclosure relates to a method for providing information on locations of an electronic device and another electronic device with regard to flight, and the electronic device. One particular implementation relates to a method for providing information on locations of an electronic device and another electronic device based on coordinate information of a matrix corresponding to a three-dimensional space, and the electronic device.

### DESCRIPTION OF THE RELATED ART

In the modern society, the penetration of automobiles which is a typical example of ground transportation means is rapidly increasing. Yet, the number and penetration of roads are not enough to catch up with the increasing rate of automobile production. As a result, an over-sufficient amount of automobiles leads to traffic congestion, waste of fuel, etc.

The conditions of the ground transportation are getting worse, and air transportation means (e.g., an air plane, a flying car) allowing for fast movement are drawing more and more attention as a replacement of the ground transportation.

Meanwhile, ground transportation means move on roads and thus utilizes information on the roads. Yet, air transportation means does not have a reference like the ground surface. Thus, information on space different from and more complicated than the information on the roads needs to be utilized for movement.

However, regarding movement of air transportation, technologies for generating space information and providing such information have been so far not yet developed sufficiently. Therefore, there are demands for a method for more effectively generating space information and providing such information in order to improve flying stability and convenience of an aerial transportation.

### SUMMARY

An aspect provides a method for more effectively providing flight-related information by displaying information on another electronic device on a three-dimensional map including auxiliary lines corresponding to three-dimensional coordinates, and a device for the same.

The technical objects, which are intended to be solved in the present disclosure, are not limited to the foregoing and may include objects that can be clearly appreciated by those skilled in the art to which the technical field of the present disclosure pertains.

In an aspect of the present disclosure, there is provided a method for providing information at an electronic device, the method including identifying location information of the electronic device, displaying a three-dimensional map associated with a location of the electronic device and comprising auxiliary lines corresponding to three-dimensional coordinates, receiving, from another electronic device, a first message comprising location information of the another electronic device, and, based on the first message, displaying information on the another electronic device on the three-dimensional map by taking into account the auxiliary lines. At least one of the location information of the electronic device or the location information of the another electronic device may include coordinate information of a matrix corresponding to a three-dimensional space.

In another aspect, there is provided an electronic device, including a transceiver configured to communicate with another electronic device, a memory configured to store information on a three-dimensional map comprising auxiliary lines corresponding to three-dimensional coordinates, and at least one processor. The at least one processor may be configured to identify location information of the electronic device, display the thee-dimensional map associated with a location of the electronic device, receive, from the another electronic device a first message comprising location information of the another electronic device, and based on the first message, display information on the another electronic device on the three-dimensional map by taking into consideration the auxiliary lines. At least one of the location information of the electronic device or the location information of the another electronic device may include coordinate information of a matrix corresponding to a three-dimensional space.

In yet another aspect, there is provided a computer-readable recording medium programed to identify location information of the electronic device, display a three-dimensional map associated with a location of the electronic device and comprising auxiliary lines corresponding to three-dimensional coordinates, receive, from another electronic device, a first message comprising location information of the another electronic device, and display information on the another electronic device on the three-dimensional map by taking into consideration the auxiliary lines based on the first message. At least one of the location information of the electronic device or the location information of the another electronic device may include coordinate information of a matrix corresponding to a three-dimensional space.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an AI device according to an embodiment of the present disclosure.

FIG. 2 illustrates an AI server according to an embodiment of the present disclosure.

FIG. 3 is an AI system according to an embodiment of the present disclosure.

FIG. 4 is a diagram for explaining a control operation of a vehicle in accordance with information transmission and reception between an operating device and a 5G network according to an embodiment of the present disclosure.

FIG. 5 is a block diagram of a wireless communication system to which a method according to an embodiment of the present disclosure may be applied.

FIG. 6 is a diagram illustrating an example of a signal transmitting and receiving method performed in a wireless communication system according to an embodiment of the present disclosure.

FIG. 7 is a diagram for conceptually explaining a method for providing flight information according to an embodiment of the present disclosure.

FIG. 8 is a diagram illustrating a three-dimensional map according to an embodiment of the present disclosure.

FIG. 9 is a diagram illustrating an example of coordinate information of a three-dimensional map according to an embodiment of the present disclosure.

FIG. 10 is a functional block diagram of an electronic device according to an embodiment of the present disclosure.

FIG. 11 is a flowchart illustrating operations of a method for providing flight information according to an embodiment of the present disclosure.

FIG. 12 is a diagram for explaining shape change of a three-dimensional map according to an embodiment of the present disclosure.

FIG. 13 is a diagram illustrating an example in which an electronic device transmits and receives information with respect to another electronic device according to an embodiment of the present disclosure.

FIG. 14 is a diagram conceptually illustrating a method for identifying a landing route of an electronic device according to an embodiment of the present disclosure.

FIG. 15 is a signal flowchart regarding location adjustment of an electronic device according to an embodiment of the present disclosure.

FIG. 16 is a flowchart of landing-related operations of a method for providing flight information according to an embodiment of the present disclosure.

### DETAILED DESCRIPTION

Exemplary embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operations to be performed on the computer or other programmable apparatus to produce a computer implemented process such that the instructions which are executed on the computer or other programmable apparatus provide operations for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

In addition, a controller mentioned in the embodiments may include at least one processor that is operated to control a corresponding apparatus.

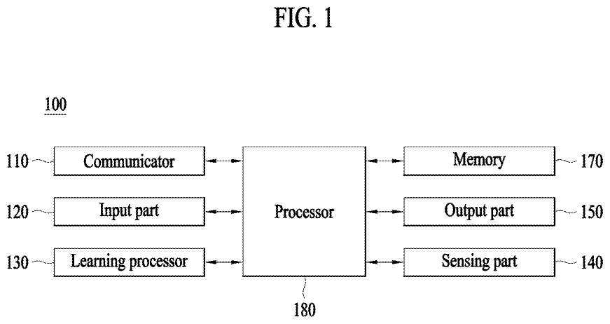

FIG. 1 illustrates an AI device 100 according to an embodiment of the present disclosure.

The AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a DMB receiver, a radio, a washing machine, a refrigerator, a digital signage, a robot, or a vehicle.

Referring to FIG. 1, a terminal 100 may include a communicator 110, an input part 120, a learning processor 130, a sensing part 140, an output part 150, a memory 170, and a processor 180, for example.

The communicator 110 may transmit and receive data to and from external devices, such as other AI devices 100a to 100e and an AI server 200, using wired/wireless communication technologies. For example, the communicator 110 may transmit and receive sensor information, user input, learning models, and control signals, for example, to and from external devices.

In this case, the communication technology used by the communicator 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

The input part 120 may acquire various types of data.

In this case, the input part 120 may include a camera for the input of an image signal, a microphone for receiving an audio signal, and a user input part for receiving information input by a user, for example. Here, the camera or the microphone may be handled as a sensor, and a signal acquired from the camera or the microphone may be referred to as sensing data or sensor information.

The input part 120 may acquire, for example, input data to be used when acquiring an output using learning data for model learning and a learning model. The input part 120 may acquire unprocessed input data, and in this case, the processor 180 or the learning processor 130 may extract an input feature as pre-processing for the input data.

The learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

In this case, the learning processor 130 may perform AI processing along with a learning processor 240 of the AI server 200.

In this case, the learning processor 130 may include a memory integrated or embodied in the AI device 100. Alternatively, the learning processor 130 may be realized using the memory 170, an external memory directly coupled to the AI device 100, or a memory held in an external device.

The sensing part 140 may acquire at least one of internal information of the AI device 100 and surrounding environmental information and user information of the AI device 100 using various sensors.

In this case, the sensors included in the sensing part 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

The output part 150 may generate, for example, a visual output, an auditory output, or a tactile output.

In this case, the output part 150 may include, for example, a display that outputs visual information, a speaker that outputs auditory information, and a haptic module that outputs tactile information.

The memory 170 may store data which assists various functions of the AI device 100. For example, the memory 170 may store input data acquired by the input part 120, learning data, learning models, and learning history, for example.

The processor 180 may determine at least one executable operation of the AI device 100 based on information determined or generated using a data analysis algorithm or a machine learning algorithm. Then, the processor 180 may control constituent elements of the AI device 100 to perform the determined operation.

To this end, the processor 180 may request, search, receive, or utilize data of the learning processor 130 or the memory 170, and may control the constituent elements of the AI device 100 so as to execute a predictable operation or an operation that is deemed desirable among the at least one executable operation.

In this case, when connection of an external device is necessary to perform the determined operation, the processor 180 may generate a control signal for controlling the external device and may transmit the generated control signal to the external device.

The processor 180 may acquire intention information with respect to user input and may determine a user request based on the acquired intention information.

In this case, the processor 180 may acquire intention information corresponding to the user input using at least one of a speech to text (STT) engine for converting voice input into a character string and a natural language processing (NLP) engine for acquiring natural language intention information.

In this case, at least a part of the STT engine and/or the NLP engine may be configured with an artificial neural network learned according to a machine learning algorithm. Then, the STT engine and/or the NLP engine may have learned by the learning processor 130, may have learned by the learning processor 240 of the AI server 200, or may have learned by distributed processing of the processors 130 and 240.

The processor 180 may collect history information including, for example, the content of an operation of the AI device 100 or feedback of the user with respect to an operation, and may store the collected information in the memory 170 or the learning processor 130, or may transmit the collected information to an external device such as the AI server 200. The collected history information may be used to update a learning model.

The processor 180 may control at least some of the constituent elements of the AI device 100 in order to drive an application program stored in the memory 170. Moreover, the processor 180 may combine and operate two or more of the constituent elements of the AI device 100 for the driving of the application program.

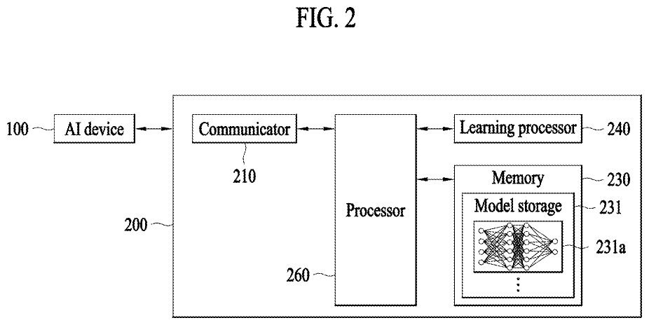

FIG. 2 illustrates the AI server 200 according to an embodiment of the present disclosure.

Referring to FIG. 2, the AI server 200 may refer to a device that causes an artificial neural network to learn using a machine learning algorithm or uses the learned artificial neural network. Here, the AI server 200 may be constituted of multiple servers to perform distributed processing, and may be defined as a 5G network. In this case, the AI server 200 may be included as a constituent element of the AI device 100 so as to perform at least a part of AI processing together with the AI device 100.

The AI server 200 may include a communicator 210, a memory 230, a learning processor 240, and a processor 260, for example.

The communicator 210 may transmit and receive data to and from an external device such as the AI device 100.

The memory 230 may include a model storage 231. The model storage 231 may store a model (or an artificial neural network) 231a which is learning or has learned via the learning processor 240.

The learning processor 240 may cause the artificial neural network 231a to learn learning data. A learning model may be used in the state of being mounted in the AI server 200 of the artificial neural network, or may be used in the state of being mounted in an external device such as the AI device 100.

The learning model may be realized in hardware, software, or a combination of hardware and software. In the case in which a part or the entirety of the learning model is realized in software, one or more instructions constituting the learning model may be stored in the memory 230.

The processor 260 may deduce a result value for newly input data using the learning model, and may generate a response or a control instruction based on the deduced result value.

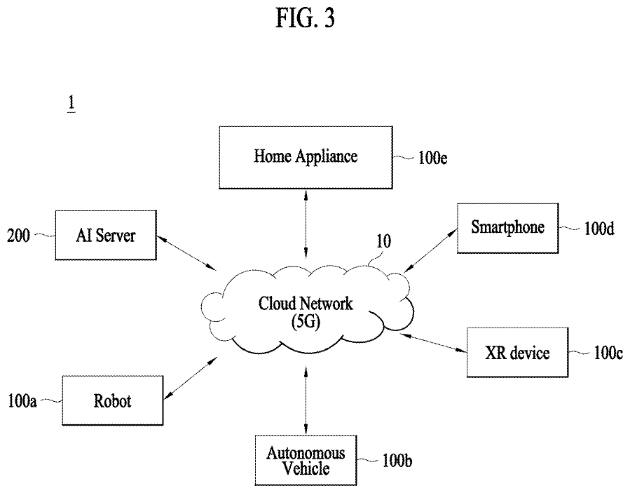

FIG. 3 illustrates an AI system 1 according to an embodiment of the present disclosure.

Referring to FIG. 3, in the AI system 1, at least one of an AI server 200, a robot 100a, an autonomous vehicle 100b, an XR device 100c, a smart phone 100d, and a home appliance 100e is connected to a cloud network 10. Here, the robot 100a, the autonomous vehicle 100b, the XR device 100c, the smart phone 100d, and the home appliance 100e, to which AI technologies are applied, may be referred to as the AI devices 100a to 100e.

The Cloud network 10 may constitute a part of a cloud computing infra-structure, or may mean a network present in the cloud computing infra-structure. Here, the cloud network 10 may be configured using a 3G network, a 4G or long term evolution (LTE) network, or a 5G network, for example.

That is, the respective devices 100a to 100e and 200 constituting the AI system 1 may be connected to each other via the cloud network 10. In particular, the respective devices 100a to 100e and 200 may communicate with each other via a base station, or may perform direct communication without the base station.

The AI server 200 may include a server which performs AI processing and a server which performs an operation with respect to big data.

The AI server 200 may be connected to at least one of the robot 100a, the autonomous vehicle 100b, the XR device 100c, the smart phone 100d, and the home appliance 100e, which are AI devices constituting the AI system 1, via the cloud network 10, and may assist at least a part of AI processing of the connected AI devices 100a to 100e.

In this case, instead of the AI devices 100a to 100e, the AI server 200 may cause an artificial neural network to learn according to a machine learning algorithm, and may directly store a learning model or may transmit the learning model to the AI devices 100a to 100e.

In this case, the AI server 200 may receive input data from the AI devices 100a to 100e, may deduce a result value for the received input data using the learning model, and may generate a response or a control instruction based on the deduced result value to transmit the response or the control instruction to the AI devices 100a to 100e.

Alternatively, the AI devices 100a to 100e may directly deduce a result value with respect to input data using the learning model, and may generate a response or a control instruction based on the deduced result value.

Hereinafter, various embodiments of the AI devices 100a to 100e, to which the above-described technology is applied, will be described. Here, the AI devices 100a to 100e illustrated in FIG. 3 may be specific embodiments of AI device 100 illustrated in FIG. 1.

The autonomous vehicle 100b may be realized into a mobile robot, a vehicle, or an unmanned aerial vehicle, for example, through the application of AI technologies.

The autonomous vehicle 100b may include an autonomous driving control module for controlling an autonomous driving function, and the autonomous driving control module may mean a software module or a chip realized in hardware. The autonomous driving control module may be a constituent element included in the autonomous vehicle 100b, but may be a separate hardware element outside the autonomous vehicle 100b so as to be connected to the autonomous vehicle 100b.

The autonomous vehicle 100b may acquire information on the state of the autonomous vehicle 100b using sensor information acquired from various types of sensors, may detect (recognize) the surrounding environment and an object, may generate map data, may determine a movement route and a driving plan, or may determine an operation.

Here, the autonomous vehicle 100b may use sensor information acquired from at least one sensor among a lidar, a radar, and a camera in the same manner as the robot 100a in order to determine a movement route and a driving plan.

In particular, the autonomous vehicle 100b may recognize the environment or an object with respect to an area outside the field of vision or an area located at a predetermined distance or more by receiving sensor information from external devices, or may directly receive recognized information from external devices.

The autonomous vehicle 100b may perform the above-described operations using a learning model configured with at least one artificial neural network. For example, the autonomous vehicle 100b may recognize the surrounding environment and the object using the learning model, and may determine a driving line using the recognized surrounding environment information or object information. Here, the learning model may be directly learned in the autonomous vehicle 100b, or may be learned in an external device such as the AI server 200.

In this case, the autonomous vehicle 100b may generate a result using the learning model to perform an operation, but may transmit sensor information to an external device such as the AI server 200 and receive a result generated by the external device to perform an operation.

The autonomous vehicle 100b may determine a movement route and a driving plan using at least one of map data, object information detected from sensor information, and object information acquired from an external device, and a drive part may be controlled to drive the autonomous vehicle 100b according to the determined movement route and driving plan.

The map data may include object identification information for various objects arranged in a space (e.g., a road) along which the autonomous vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, the autonomous vehicle 100b may perform an operation or may drive by controlling the drive part based on user control or interaction. In this case, the autonomous vehicle 100b may acquire interactional intention information depending on a user operation or voice expression, and may determine a response based on the acquired intention information to perform an operation.

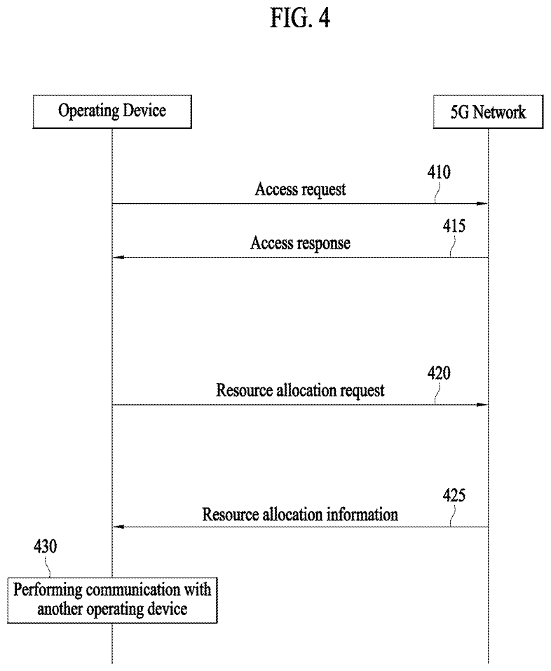

FIG. 4 is a diagram illustrating an operation of controlling a vehicle in response to information being transmitted and received between an operating device and a 5G network according to an example embodiment.

FIG. 4 illustrates a communication method performed between an operating device and a 5G network. In the example embodiment, the operating device may be included in an apparatus for collecting an item. For example, the operating device may be included in a robot for collecting an item.

In operation 410, the operating device may transmit an access request to the 5G network. The access request may be received by a base station and transmitted on a channel for transmitting an access request. The access request may include information for identifying the operating device.

In operation 415, the 5G network may transmit a response to the access request to the operating device. The response to the access request, for example, an access response, may include identification information to be used when the operating device receives information. Also, the access response may include wireless resource allocation information for transmitting and receiving information of the operating device.

In operation 420, the operating device may transmit a wireless resource allocation request for communicating with another device or a base station based on the received information. The wireless resource allocation request may include at least one of information on an operating device and information on a counterpart node for performing communication.

In operation 425, the 5G network may transmit wireless resource allocation information to the operating device. The wireless resource allocation information may be determined based on at least a portion of the information transmitted in operation 420. For example, information associated with resources allocated to communicate with another operating device and identification information to be used for the corresponding communication may be included in the wireless resource allocation information. For example, communication with another operating device may be performed on a channel for device-to-device communication.

In operation 430, the operating device may perform communication with another operating device based on the received information.

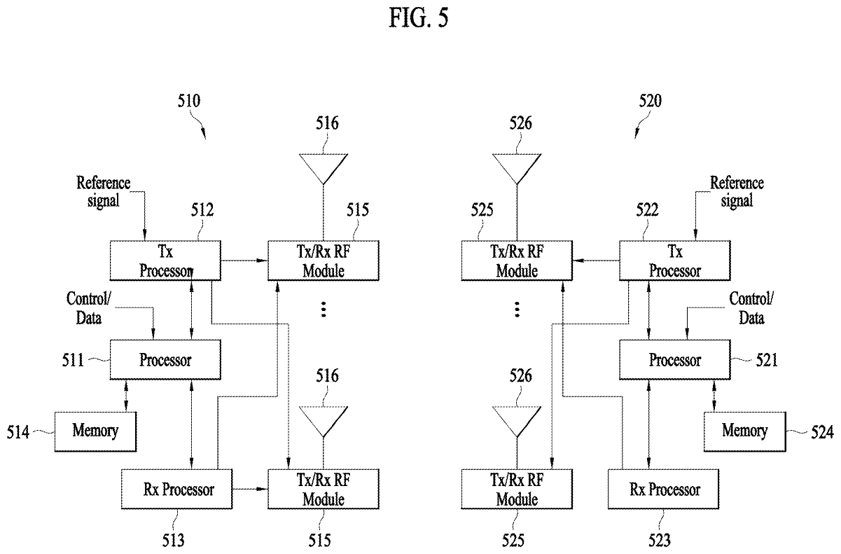

FIG. 5 is a block diagram of a wireless communication system to which a method according to an embodiment of the present disclosure can be applied.

Referring to FIG. 5, an apparatus (an autonomous driving apparatus) including an autonomous driving module may be defined as a first communication device 510, and a processor 511 may perform detailed autonomous driving operations.

A 5G network including another vehicle capable of communicating with the autonomous driving apparatus may be defined as a second communication device 520, and a processor 521 may perform detailed autonomous driving operations.

The 5G network may be expressed as a first communication device, and the autonomous driving apparatus may be expressed as a second communication device.

For example, the first communication device or the second communication device may be a base station, a network node, a Tx terminal, an Rx terminal, a wireless device, a wireless communication device, an autonomous driving apparatus, etc.

For example, a terminal or User Equipment (UE) may include a vehicle, a mobile phone, a smart phone, a laptop computer, a personal digital assistant (PDA), a portable multimedia player (PMP), a navigation, a slate PC, a tablet PC, an ultrabook, a wearable device (e.g., a smartwatch, a smart glass, a head mounted display (HMD)), etc. The HMD may be a display device which can be worn on a user's head. For example, the HMD may be used to realize virtual reality (VR), augmented reality (AR), and mixed reality (MR). Referring to FIG. 1, the first communication device 510 and the second communication device 520 includes processors 511 and 521, memories 514 and 524, one or more Tx/Rx radio frequency (RF) modules 515 and 525, Tx processors 512 and 522, Rx processors 513 and 523, and antennas 516 and 526. A Tx/Rx module may be referred to as transceivers. Each Tx/RX module transmits a signal through the antenna 526. The processor performs the above-described functions, processes, and/or methods. The processor 521 may be related to the memory 524 for storing program codes and data. The memory may be referred to as a computer readable medium. More specifically, in the DL (communication from the first communication device to the second communication), the Tx processor 512 implements various signal processing functions of L1 layer (that is, physical layer). The Rx processor implements various signal processing functions of the L1 layer (that is, physical layer).

The UL (communication from the second communication device to the first communication device) is implemented in the first communication device 510 in a manner similar to the above-description regarding receiver functions in the second communication device 520. Each Tx/Rx module 525 may receive a signal through the antenna 526. Each Tx/Rx module provides a RF subcarrier and information to the Rx processor 523. The processor 521 may be related to the memory 524 for storing program codes and data. The memory may be referred to as a computer readable medium.

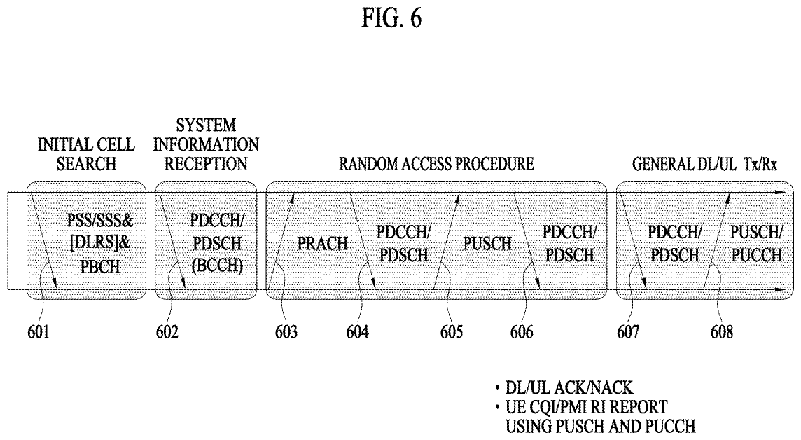

FIG. 6 is a diagram illustrating a method of transmitting and receiving a signal in a wireless communication system according to an example embodiment.

FIG. 6 illustrates an example of a signal transmission/reception method in a wireless communication system.

Referring to FIG. 6, when UE is powered on or enters a new cell, the UE may perform initial cell search such as synchronization with a BS (601). To this end, the UE may receive a primary synchronization channel (P-SCH) and a secondary synchronization channel (S-SCH) from the BS to synchronize with the BS, and may acquire information such as a cell ID. In an LTE system and an NR system, the P-SCH and the S-SCH may be called a primary synchronization signal (PSS) and a secondary synchronization signal (SSS), respectively. After the initial cell search, the UE may acquire broadcast information in the cell by receiving a physical broadcast channel (PBCH) from the BS. Meanwhile, the UE may check the state of a downlink channel by receiving a downlink reference signal (DL RS) during the initial cell search. After completing the initial cell search, the UE may acquire more specific system information by receiving a physical downlink control channel (PDCCH) and a physical downlink shared channel (PDSCH) based on information on the PDCCH (602).

When the UE initially accesses the BS or when there is no radio resource for signal transmission, the UE may perform a random access procedure (RACH) for the BS (603 to 606). To this end, the UE may transmit a specific sequence as a preamble through a physical random access channel (PRACH) (603 and 605), and may receive a random access response (RAR) message for the preamble through the PDCCH and the PDSCH (604 and 606). In the case of contention-based RACH, the UE may additionally perform a contention resolution procedure.

After performing the above-described procedure, the UE may perform, as general uplink/downlink signal transmission procedures, PDCCH/PDSCH reception (607) and physical uplink shared channel (PUSCH)/physical uplink control channel (PUCCH) transmission (208). In particular, the UE may receive downlink control information (DCI) through the PDCCH. The UE may monitor a set of PDCCH candidates at monitoring occasions which are set in one or more control element sets (CORESETs) on a serving cell according to search space configurations. The set of PDCCH candidates to be monitored by the UE may be defined in terms of search space sets, and such a search space set may be a common search space set or a UE-specified search space set. The CORESET is composed of a set of (physical) resource blocks having a time duration of 1 to 3 OFDM symbols. The network may set the UE to have multiple CORESETs. The UE may monitor PDCCH candidates in one or more search space sets. Here, monitoring may refer to attempting to decode PDCCH candidate(s) in a search space. When the UE has succeeded in decoding one of the PDCCH candidates in the search space, the UE may determine that a PDCCH has been detected in a PDCCH candidate, and may perform PDSCH reception or PUSCH transmission based on DCI on the detected PDCCH. The PDCCH may be used to schedule DL transmissions through the PDSCH and UL transmissions through the PUSCH. Here, the DCI on the PDCCH may include downlink assignment (i.e., downlink (DL) grant) including at least modulation, coding format, and resource allotment information associated with a downlink shared channel or uplink (UL) grant including modulation, coding format, and resource allotment information associated with an uplink shared channel.

Referring to FIG. 6, initial access (IA) in the 5G communication system will be further described.

The UE may perform cell search, system information acquisition, beam alignment for initial access, and DL measurement based on an SSB. The SSB may be mixed with a synchronization signal/physical broadcast channel (SS/PBCH) block.

The SSB may be composed of a PSS, an SSS, and a PBCH. The SSB may be composed of four consecutive OFDM symbols, and the PSS, PBCH, SSS/PBCH, or PBCH may be transmitted for each OFDM symbol. Each of the PSS and SSS may be composed of 1 OFDM symbol and 127 subcarriers, and the PBCH may be composed of 3 OFDM symbols and 576 subcarriers.

The cell search may refer to a procedure in which the UE acquires time/frequency synchronization of a cell and detects a cell identifier (ID) (e.g., a physical layer cell ID (PCI)) of the cell. The PSS may be used to detect a cell ID in a cell ID group, and the SSS may be used to detect the cell ID group. The PBCH may be used for SSB (time) index detection and half-frame detection.

There may be 336 cell ID groups, and three cell IDs may exist for each cell ID group. Thus, a total of 1008 cell IDs may exist. Information on a cell ID group, to which a cell ID of a cell belongs, may be provided or acquired through the SSS of the cell, and information on a cell ID among cell IDs of 336 cell ID groups may be provided or acquired through the PSS.

The SSB may be transmitted periodically based on the periodicity of the SSB. An SSB basic period assumed by the UE at the time of initial cell search may be defined as 20 ms. After the cell access, the periodicity of the SSB may be set to one of 5 ms, 10 ms, 20 ms, 40 ms, 80 ms, and 160 ms by a network (e.g., BS).

Next, acquisition of system information (SI) will be described.

The SI may include a master information block (MIB) and multiple system information blocks (SIBs). The SI other than the MIB may be referred to as remaining minimum system Information (RMSI). The MIB may include information/parameters for monitoring the PDCCH which schedules the PDSCH carrying system information block 1 (SIB1), and may be transmitted by the BS through the PBCH of the SSB. The SIB1 may include information on the availability and scheduling (e.g., a transmission period and an SI-window size) of the remaining SIBs (hereinafter, SIBx (x being an integer of 2 or more)). The SIBx may be included in an SI message and may be transmitted through the PDSCH. Each SI message may be transmitted within a time window (i.e., an SI-window) which periodically occurs.

Referring to FIG. 6, random access (RA) in the 5G communication system will be further described.

The random access may be used for various purposes. For example, the random access may be used for network initial access, handover, and UE-triggered UL data transmission. The UE may acquire UL synchronization and UL transmission resources through the random access. The random access may be classified into contention-based random access and contention-free random access. A detailed procedure for the contention-based random access is as follows.

The UE may transmit a random access preamble as an Msg1 of the random access in UL through the PRACH. Random access preamble sequences having two different lengths may be supported. A Long sequence length of 839 may be applied to a subcarrier spacing of 1.25 kHz or 5 kHz, and a short sequence length of 139 may be applied to a subcarrier spacing of 15 kHz, 30 kHz, 60 kHz, or 120 kHz.

When the BS receives the random access preamble from the UE, the BS may transmit a random access response (RAR) message (Msg2) to the UE. The PDCCH which schedules the PDSCH including the RAR may be transmitted by being CRC-masked with a random access (RA) radio network temporary identifier (RNTI) (RA-RNTI). The UE, which has detected the PDCCH masked with the RA-RNTI, may receive the RAR from the PDSCH scheduled by the DCI carried by the PDCCH. The UE may check whether random access response information for the preamble transmitted by the UE, i.e., Msg1, is in the RAR. Whether the random access response information for the Msg1 transmitted by the UE is in the RAR may be determined by whether there is a random access preamble ID for the preamble transmitted by the UE. When there is no response to the Msg1, the UE may retransmit the RACH preamble a predetermined number of times while performing power ramping. The UE may calculate PRACH transmission power for retransmission of the preamble based on the most recent path loss and a power ramping counter.

The UE may transmit, as an Msg3 of the random access, UL transmission through the uplink shared channel based on the random access response information. The Msg3 may include an RRC connection request and an UE identifier. As a response to the Msg3, the network may transmit an Msg4, which may be treated as a contention resolution message in DL. By receiving the Msg4, the UE may enter an RRC-connected state.

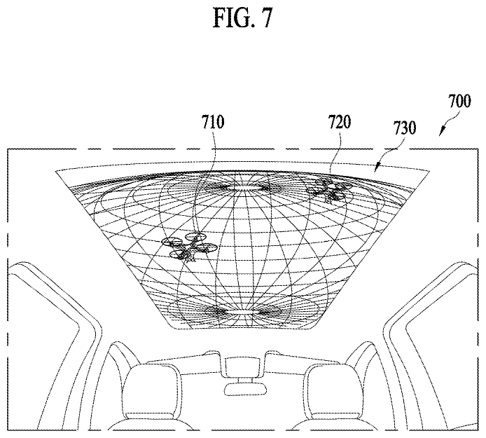

FIG. 7 is a view conceptually illustrating a method for providing flight information according to an embodiment of the present disclosure. Specifically, FIG. 7 illustrates an example in which a three-dimensional map and information on another electronic device are displayed.

An electronic device for providing flight information may be included in a vehicle 700 and may provide the flight information through at least part of the vehicle 700 (e.g., a top display 730), as shown in FIG. 7.

The flight information may include, when a flying object (e.g., a flying car) including an electronic device flies, information within a predetermined distance (e.g., a visible distance) from a user present in the flying object. The flight information may include a three-dimensional map including auxiliary lines corresponding to three-dimensional coordinates and information on another electronic device (e.g., an electronic device of a first vehicle 710 and an electronic device of a second vehicle 720). In this case, the another electronic device may be located within the predetermined distance from the electronic device.

The flight information may be provided in various manners. For example, as shown in FIG. 7, the flight information may be displayed through the top window 730 of the vehicle 700 including the electronic device. In this case, the top window 730 may be implemented in the form of a Head-Up Display (HUD) and formed in the ceiling of the vehicle 700. However, aspects of the present disclosure are not limited thereto, and the flight information may be displayed through a different portion of the vehicle 700, for example, a front window, a left window, or a right window.

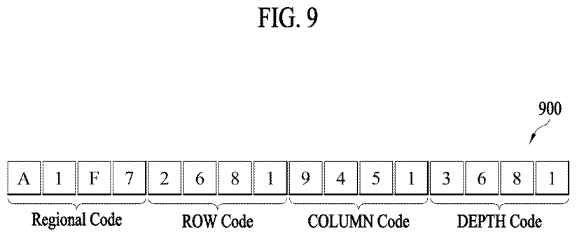

The flight information may be, as illustrated in the drawings, provided such that a location of another device (or another vehicle) is shown on a three-dimensional map. In this case, the location of the another vehicle may be displayed on the three-dimensional map based on coordinate information of a matrix that corresponds to a three-dimensional space in relation with the three-dimensional map. A more specific example of the coordinate information may refer to FIG. 9.

The three-dimensional map may be generated in units of cells each comprised of a width, a length, and a height that are predesignated based on the auxiliary lines. Each cell in the three-dimensional map may include coordinate information indicating a location of a corresponding cell. In doing so, when the another other electronic device (e.g., the first vehicle 710 and the second vehicle 720) is displayed, it is possible to identify the location of the another electronic device more easily.

In addition, in some cases, when an object other than the electronic device, for example, a building, is positioned at a location corresponding to a cell, the corresponding cell may include information on the object. For example, when a space meant by a first cell corresponds to a building, the first cell may include information indicating that the first cell is a building, as well as information on a location of the first cell.

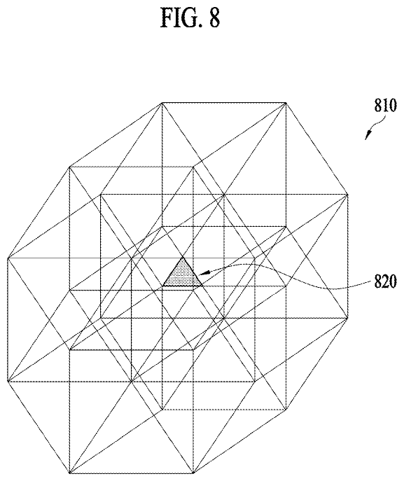

FIG. 8 is a diagram illustrating a three-dimensional map according to an embodiment of the present disclosure.

Referring to FIG. 8, a three-dimensional map 810 may be formed of a plurality of cells. The plurality of cells may take various forms and may be, for example, in the form of a quadrangular pyramid as shown in FIG. 8. However, aspects of the present disclosure are not limited thereto, and the plurality of cells may be represented by, for example, a rectangular box.

The three-dimensional map 810 displayed by an electronic device may be at least part of a three-dimensional map that is pre-generated for a particular area. For example, when the pre-generated three-dimensional map is a map of a space at an altitude equal to or lower than 50 meter from the ground of Seoul and the electronic device is currently located in Magok-dong within Seoul, the three-dimensional map displayed by the electronic device may be a map of Magok-dong. That is, the three-dimensional map 810 may include a map of an area within a predetermined distance from the location of the electronic device, that is, the surroundings of the electronic device.

If another electronic device 820 is present in the surroundings of the electronic device, the another electronic device 820 may be displayed on the three-dimensional map 810. A location of the another electronic device 820 displayed on the three-dimensional map 810 may be represented with reference to the electronic device. For example, when the another electronic device 820 is located ahead of the electronic device in a direction of travel of the electronic device, the three-dimensional map 810 may displayed on a front window and the another electronic device 820 may be displayed on the three-dimensional map 810. In doing so, it is possible to identify a state of the another electronic device 820 more easily.

FIG. 9 is a view illustrating an example of coordinate information of a three-dimensional map according to an embodiment of the present disclosure.

Referring to FIG. 9, coordinate information 900 may include a regional code, a ROW code, COLUMN code, and a DEPTH code.

The regional code may be information indicating that a particular cell included in a three-dimensional map corresponds to which region in the whole regions represented by a pre-generated three-dimensional map. For example, when the pre-generated three-dimensional map is of Seoul and the particular cell is of Magok-dong, which is a part of Seoul, the regional code may include information on Magok-dong. In some cases, the information indicating Magok-dong may be represented in the form of a predetermined code (e.g., A1F7), as illustrated.

The ROW code may be information on a width of the particular cell included in the three-dimensional map. For example, the ROW code may include information on an actual distance corresponding to a width of the cell or information on a width coordinate in the three-dimensional map. In some cases, each type of the aforementioned information may be represented by a predetermined value (e.g., 2681), as illustrated in the drawing.

The COLUMN code may be information on a width of a particular cell included in the three-dimensional map. For example, the COLUMN code may include information on an actual distance corresponding to a length of the cell or information on a length coordinate in the three-dimensional map. In some cases, each type of the aforementioned information may be represented by a predetermined value (e.g., 9451), as shown in the drawing.

The DEPTH code may be information indicating a height of a particular cell included in the three-dimensional map. For example, the DEPTH code may include information on an actual distance corresponding to a height of the cell or information on a height coordinate on the three-dimensional map. In some cases, each type of such information may be represented by a predetermined value (e.g., 3681) according to a corresponding type of the information.

As such, each of the plurality of cells included in the three-dimensional map may have coordinate information and a particular cell on the three-dimensional map may be identified based on the coordinate information. Meanwhile, the coordinate information shown in FIG. 9 is merely exemplary, and aspects of the present disclosure are not limited thereto and the coordinate information may be implemented in various ways. For example, a sequence order of respective codes of the coordinate information may be changed, and the coordinate information may be represented not in the form of a serial number but in the form of coordinates such as (A1F7,2681,9451,3681).

In some cases, the coordinate information may include information on a particular location (e.g., a point) on the three-dimensional map. Here, the particular location on the three-dimensional map may be in a unit smaller than a cell and may correspond to a part of a cell. When the coordinate information includes information on the particular location, more specific location information may be provided.

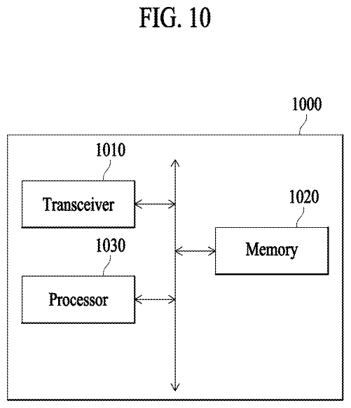

FIG. 10 is a function block diagram of an electronic device according to an embodiment of the present disclosure. Each component may be a unit that processes at least one function or operation and this may be implemented by hardware or software or a combination of hardware and software.

In an embodiment, the electronic device may be included in a vehicle (or a flying device), and a location or movement of the electronic device may correspond to a location or movement of the vehicle including the electronic device. In addition, the electronic device may be interpreted as a vehicle, a device attachable to a vehicle, a vehicle control device, or the like.

Referring to FIG. 10, an electronic device 1000 may include a transceiver 1010, a memory 1020, and a processor 1030. The transceiver 1010, the memory 1020, and the processor 1030 may be respectively implemented by an operating device including a microprocessor.

The transceiver 1010 may transmit information from another electronic device or transmit information to the another electronic device based on vehicle-to-everything (V2X) communication. For example, the transceiver 1010 may receive information on the another electronic device from the another electronic device based on communication with the another electronic device.

Here, the information on the another electronic device may include at least one of the following: time information corresponding to transmission of the information, information on accuracy of coordinate information of a three-dimensional map, information on the latitude of the another electronic device, information on the longitude of the another electronic device, information on the altitude of the another electronic device, information on a moving speed of the another electronic device, information on a moving direction of the another electronic device, information on a moving state of the another electronic device, information on a moving state of the another electronic device, information on a size of the another electronic device, information on a previous route of the another electronic device, and information on a predicted route of the another electronic device.

The information on the another electronic device may be referred to as a first message in some implementations, but the present disclosure is not limited to such a term.

In some cases, the transceiver 1010 may transmit information on the electronic device 1000 to the electronic device 1000. The information on the electronic device 1000 may include at least one of the following: time information corresponding to transmission of the information, information on accuracy of coordinate information of a three-dimensional map, information on the latitude of the electronic device 1000, information on the longitude of the electronic device 1000, information on the altitude of the electronic device 1000, information on a moving speed of the electronic device 1000, information on a moving direction of the electronic device 1000, information on a moving state of the electronic device 1000, information on a moving state of the electronic device 1000, information on a size of the electronic device 1000, information on a previous route of the electronic device 1000, and information on a predicted route of the electronic device 1000.

The memory 1020 may include at least one instruction for operation of the electronic device 1000. The at least one instruction stored in the memory 1020 may be executed by the processor 1030. Operations of the processor 1030 described below may be implemented as such an instruction is executed.

The memory 1020 may store a variety of information related to operation of the electronic device 1000. For example, the memory 1020 may store information on an application for displaying a three-dimensional map. In another example, the memory 1020 may store information on the three-dimensional map including auxiliary lines corresponding to three-dimensional coordinates, and information on a non-line of site (NLOS) (or non-visible distance) area and a line of site (LOS) (or visible distance) area on the three-dimensional map. The NLOS area and the LOS area are predesignated, and thus, a detailed description thereof as would be apparent to one skilled in the art will be herein omitted.

The processor 1030 may identify location information of the electronic device 1000. In an embodiment, the electronic device 1000 may be included in a vehicle, and, in this case, the location information of the electronic device 1000 may correspond to location information of the vehicle.

In some cases, a sensor (e.g., a global positioning sensor (GPS)) for acquiring location information may be included in the electronic device 1000, and the processor 1030 may identify the location information of the electronic device 1000 based on the sensor.

The location information of the electronic device 1000 may include a variety of information related to a current location of the electronic device 1000. For example, the location information of the electronic device 1000 may include information on a latitude, an altitude, and a longitude of the electronic device 1000 or may include information on a location of the electronic device 1000 on the three-dimensional map.

In an embodiment, the processor 1030 may receive information on another electronic device based on a distance to the another electronic device. Specifically, when a distance between the electronic device 1000 and the another electronic device satisfies a first condition, the information on the another electronic device (or a first message) may be received in a first period, and, when the distance between the electronic device 1000 and the another electronic device satisfies a second condition, the information on the another electronic device may be received in a second period.

In this case, the first condition may be the case where the distance between the electronic device 1000 and the another electronic device is equal to or greater than a predetermined distance, and the second condition may be the case where the distance between the electronic device 1000 and the another electronic device is smaller than the predetermined distance. Here, the first period may be longer than the second period. For example, the first period may be 5 seconds, and the second period may be 1 second.

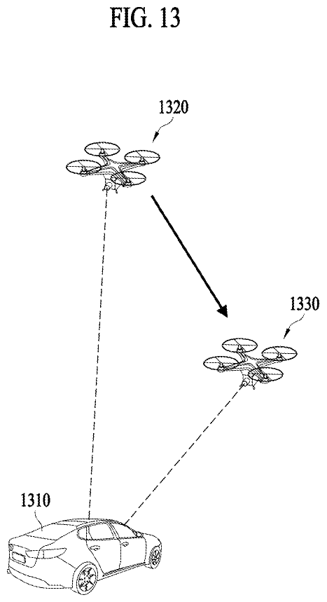

The aforementioned period of receiving information may be applied equally to a period of transmitting information. For example, when the distance between the electronic device 1000 and the another electronic device is equal to or greater than the predetermined distance, the processor 1030 may transmit the information on the electronic device 1000, and, when the distance between the electronic device 1000 and the another electronic device is smaller than the predetermined distance, the processor 1030 may transmit the information on the electronic device 1000. A specific example of such information transmission may refer to FIG. 13.

The processor 1030 may display a three-dimensional map including auxiliary lines corresponding to three-dimensional coordinates. The three-dimensional map, which is a three-dimensionally presented map generated for a space, may include auxiliary lines that implement a matrix. In this case, the matrix of the three-dimensional map may include coordinate information corresponding to each location on a three-dimensional space.

In some cases, the matrix may include a plurality of cells indicating respective spaces indicated by the auxiliary lines. In an embodiment, coordinate information may be mapped to each of the plurality of cells, and, in this case, the coordinate information may include information on a corresponding cell in the plurality of cells on the three-dimensional map (or matrix).

That is, according to an embodiment, coordinate information may represent a specific point (or spot) on the three-dimensional map or may indicate a particular cell included in the three-dimensional map.

Meanwhile, a width, a length, and a height of each of the plurality of cells may be predesignated. In doing so, the three-dimensional map may be represented in units of the plurality of cells. However, in some cases, at least one of the width, the length, or the height of each of the plurality of cells may change based on a distance between the electronic device 1000 and another electronic device.

For example, when the distance between the electronic device 1000 and the another electronic device is equal to or greater than a first value, at least one of the width, the length, or the height of each of the plurality of cells may increase by a second value. In another example, when the distance between the electronic device 1000 and the another electronic device is smaller than the first value, at least one of the width, the length, or the height of each of the plurality of cells may decrease by the second value. In this case, the shorter the distance between the electronic device 1000 and the another electronic device is, in the more detail the three-dimensional map may be displayed, for example, such that the plurality cells are displayed more densely.

In some cases, the processor 1030 may display both information on an NLOS area and information on an LOS area on the three-dimensional map. Such information may be displayed for each cell, but aspects of the present disclosure are not limited thereto. For example, when one cell includes NLOS and LOS, two types of information may be displayed for an actual corresponding area.

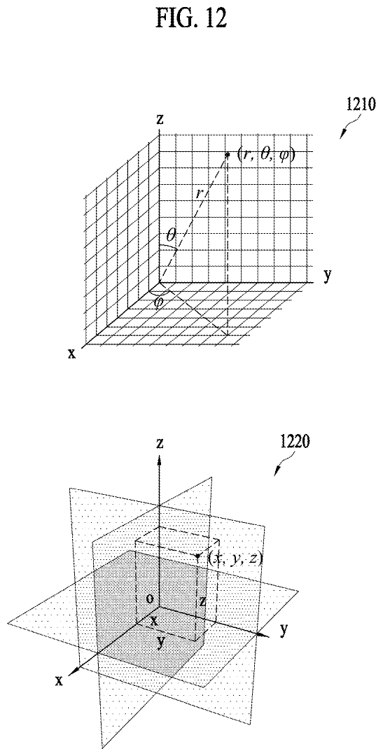

In an embodiment, the processor 1030 may change a display form of the three-dimensional map based on a distance between the electronic device 1000 and another electronic device. For example, when the distance between the electronic device 1000 and the another electronic device is smaller than a predetermined value, the processor 1030 may display the three-dimensional map by using a single three-dimensional coordinate system. When the distance between the electronic device 1000 and the another electronic device is equal to or greater than a predetermined value, the processor 1030 may display the three-dimensional map by using a spatial coordinate system. A specific example regarding the foregoing description may refer to FIG. 12.

The processor 1030 may display the three-dimensional map regarding a location of the electronic device 1000. The electronic device 1000 may include a display or may be connected to a display of a vehicle, and, in this case, the processor 1030 may display the three-dimensional map on a corresponding display. In this case, the three-dimensional map displayed on the corresponding display may be displayed with reference to the location of the electronic device 1000.

Specifically, the processor 1030 may display a three-dimensional map of a space within a predetermined distance from the location of the electronic device 1000. For example, when a display for displaying a three-dimensional map is present on a front window corresponding to a moving direction of the electronic device 1000, the processor 1030 may display a three-dimensional map of a space within a predetermined distance in a direction forward of the electronic device 1000.

In some cases, the space within the predetermined distance may be determined based on a flyable altitude. For example, the three-dimensional map may be pre-generated for an area corresponding to the flyable altitude, and the predetermined distance may be determined to be a value smaller than a distance of the area corresponding to the flyable altitude on the generated three-dimensional map.

The processor 1030 may display information on the another electronic device on the three-dimensional map by taking into consideration auxiliary lines based on received information. The processor 1030 may display a location of the another electronic device on auxiliary lines of the three-dimensional map based on the information on the another electronic device. The location of the another electronic device displayed on the three-dimensional map may be a relative location of the another electronic device viewed from the electronic device 1000 because the three-dimensional map is displayed with reference to the location of the electronic device 1000.

The processor 1030 may provide information on the another electronic device based on displaying of an icon indicating the another electronic device on the three-dimensional map. According to an embodiment, such information may be provided based on augmented reality (AR).

In some cases, when the three-dimensional map is displayed on a transparent window (or a glass window) (e.g., the front window of a vehicle), a real-world view outside the transparent window may be projected. If another electronic device is present in the surroundings of the electronic device 1000, the another electronic device itself may be seen on the transparent window. In this case, the three-dimensional map may overlap on the transparent window, and the location of the another electronic device may be more easily identified based on the auxiliary lines of the three-dimensional map.

In an embodiment, the processor 1030 may receive a second message (or signal) to request altitude adjustment from the another electronic device. In this case, the processor 1030 may change the altitude of the electronic device 1000 based on the second message.

For example, when a distance between the electronic device 1000 and the another electronic device is smaller than a predetermined distance, the processor 1030 may receive the second message from the another electronic device which has identified the distance. In order to increase the distance to the another electronic device based on the second message, the processor 1030 may increase or decrease the altitude of the electronic device 1000. If the another device is located on the ground level, the electronic device 1000 may increase the altitude thereof, thereby increasing the distance to the another electronic device.

In an embodiment, when the processor 1030 wishes to make the electronic device 1000 (or a vehicle including the electronic device 1000) land the ground (or when the altitude of the electronic device 1000 is smaller than the predetermined value), the processor 1030 may identify (or determine) a landing route based on information on the another electronic device. Specifically, the processor 1030 may identify, based on the information on the another electronic device, the landing route of the electronic device 1000, which maintains the distance to the another electronic device to the predetermined value or more.

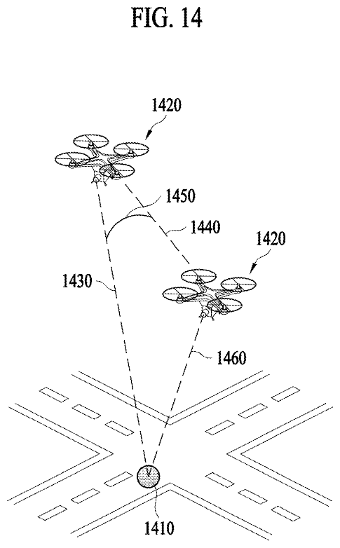

In some cases, the processor 1030 may identify a landing route by considering information on wind blowing in an area where the electronic device 1000 is located. A specific example regarding the foregoing description may refer to FIG. 14.

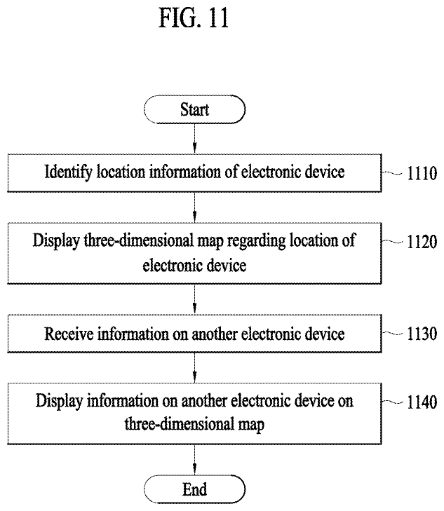

FIG. 11 is a flowchart illustrating operations of a method for providing flight information according to an embodiment of the present disclosure. It should be noted that the respective operations of the method shown in FIG. 11 may be, in some cases, implemented in an order different than depicted in FIG. 11.

Referring to FIG. 11, a processor 1030 may identify location information of an electronic device in operation 1110. The location information of the electronic device is information on a location where the electronic device is currently positioned, and the location information of the electronic device may include, for example, information on at least one of a latitude, an altitude, and a longitude of the current location of the electronic device.

The processor 1030 may display a three-dimensional map regarding the location of the electronic device in operation 1120. The processor 1030 may display a three-dimensional map regarding the surroundings of the electronic device with reference to the location of the electronic device.

The surroundings of the electronic device may be an area within a visible distance or a predetermined distance from the electronic device or may be an area within from the electronic device.

The three-dimensional map may be information on a space of a predetermined region, which is pre-generated for a predetermined area (or region). The three-dimensional map may include auxiliary lines corresponding to three-dimensional coordinates. In doing so, the three-dimensional map may be implemented in a matrix form. That is, the three-dimensional map may be implemented in a matrix form by auxiliary lines.

In an embodiment, the processor 1030 may display the three-dimensional map on a top window of a vehicle (see, FIG. 7) including a display (e.g., an electronic device 1000). The three-dimensional map displayed on the display may be about an area in the surroundings of the electronic device, which is projected through the display, with reference to a location of the electronic device. For example, when the display is a front window of a vehicle and an electronic device is included in the vehicle, the three-dimensional map may be about an area forward of the vehicle. In another example, when the display is a top window, the three-dimensional map may be about an area upward of the vehicle.

The processor 1030 may receive information on another electronic device in operation 1130. Here, the another electronic device may be located within a predetermined distance (e.g., a visible distance or a radius of 30 meter) from the electronic device and may be likely to collide with the electronic device. The another electronic device may be, for example, another vehicle.

Specifically, the processor 1030 may receive at least one of the following: time information corresponding to transmission of the information of the another electronic device by the another electronic device, information on accuracy of coordinate information, information on a latitude of the another electronic device, information on a longitude of the another electronic device, information on a height of the another electronic device, information on a moving speed of the another electronic device, information on a moving direction of the another electronic device, information on a moving state of the another electronic device, information on a size of the another electronic device, information on a previous route of the another electronic device, and information on a predicted route of the another electronic device.

In an embodiment, the processor 1030 may transmit information on the electronic device to the another electronic device, the information on the electronic device may include at least one of the following: time information corresponding to transmission of the information of the electronic device, information on accuracy of coordinate information, information on a latitude of the electronic device, information on a longitude of the electronic device, information on a height of the electronic device, information on a moving speed of the electronic device, information on a moving direction of the electronic device, information on a moving state of the electronic device, information on a size of the electronic device, information on a previous route of the electronic device, and information on a predicted route of the electronic device.

In some cases, when the electronic device attempts to land on the ground, the processor 1030 may transmit information indicating the landing of the electronic device to the another electronic device.

In an embodiment, the processor 1030 may receive the information on the another electronic device in a predetermined period that is determined according to a distance between the electronic device and the another electronic device. For example, when the distance between the electronic device and the another electronic device is equal to or greater than a predetermined distance, the processor 1030 may receive the information on the another electronic device in a first period. In another example, when the distance between the electronic device and the another electronic device is smaller than the predetermined distance, the processor 1030 may receive the information on the another electronic device in a second period. In this case, the first period may be longer than the second period, but aspects of the present disclosure are not limited thereto.

The processor 1030 may display the information on the another electronic device on a three-dimensional map in operation 1140. Based on the received information on the another electronic device, the processor 1030 may display the information on the another electronic device on the three-dimensional map. On the three-dimensional map, the information on the another electronic device may be displayed in an area corresponding to a location of the another electronic device.

In an embodiment, the processor 1030 may change a size of a plurality of cells included in the three-dimensional map, based on a distance between the electronic device and the another electronic device. For example, when the distance between the electronic device and the another electronic device is less than a predetermined value, the processor 1030 may determine the size of the plurality of cells as a first value. When the distance between the electronic device and the another electronic device is equal to or greater than the predetermined value, the processor 1030 may determine the size of the plurality of cells as a second value. In this case, the first value may be smaller than the second value. In this case, if the distance between the electronic device and the another electronic device is shorter, the three-dimensional map may be displayed in more detail.

In an embodiment, the processor 1030 may change a display form of the three-dimensional map based on the distance between the electronic device and the another electronic device. For example, when the distance between the electronic device and the another electronic device is less than a predetermined value, the processor 1030 may display the three-dimensional map by using a single coordinate system. When the distance between the electronic device and the another electronic device is equal to or greater than the predetermined value, the processor 1030 may display the three-dimensional map by using a spatial coordinate system. A specific example regarding the foregoing description may refer to FIG. 12.

Although not illustrated, in an embodiment, the processor 1030 may receive information for requesting altitude adjustment from the another electronic device. In this case, the processor 1030 may adjust an altitude of the electronic device in correspondence with the received information.

In an embodiment, when the processor 1030 wishes to make the electronic device 1000 (or a vehicle including the electronic device 1000) land on the ground (or when the altitude of the electronic device is less than a predetermined value), the processor 1030 may identify (or determine) a landing route based on the information on the another electronic device. Specifically, based on the information on the another electronic device, the processor 1030 may identify a landing route of the electronic device 1000, which maintains the distance to the another electronic device to a predetermined value or greater.

In some cases, the processor 1030 may identify a landing route by taking into consideration information on wind blowing in an area where the electronic device 1000 is located. A specific example regarding the foregoing description may refer to FIG. 14.

FIG. 12 is a view for explaining shape change of a three-dimensional map according to an embodiment of the present disclosure.

Referring to FIG. 12, when a distance between an electronic device and another electronic device is less than a predetermined value, a three-dimensional map may be displayed based on a single three-dimensional coordinate system 1210. The single three-dimensional coordinate system 1210 may refer to a coordinate system of a space having X-axis, Y-axis, and Z-axis which all have positive values.

When the distance between the electronic device and the another electronic device is equal to or greater than the predetermined value, the three-dimensional map may be displayed based on a spatial coordinate system 1220. The special coordinate system 1220 may refer to a coordinate system of a space having X-axis, Y-axis, and Z-axis which have both negative values and positive values.

In this case, the electronic device and the another electronic device are at a greater distance, a three-dimensional map regarding a larger area may be displayed. In the case where a plurality of cells has a consistent size, if the electronic device and the another electronic device are at a greater distance, a greater number of cells may be displayed.

FIG. 13 is a view illustrating an example in which an electronic device transmits and receives information with respect to another electronic device according to an embodiment of the present disclosure.

Referring to FIG. 13, the electronic device may move from a first location 1320 to a second location 1330. If the another electronic device is stopped at a third location 1310, a distance between the electronic device and the another electronic device may change due to the change in the location of the electronic device.

Specifically, as shown in FIG. 13, when the electronic device is positioned at the first location 1320, the electronic device and the another electronic device may be at a greater distance than when the electronic device is positioned at the second location 1330.

In this case, a period of receiving information on the another electronic device may be different between when the electronic device is positioned at the first location 1320 and when the electronic device is positioned at the second location 1330. For example, when the electronic device is positioned at the first location 1320, the electronic device may receive the information on the another electronic device in a first period, and, when the electronic device is positioned at the second location 1330, the electronic device may receive the information on the another electronic device in a second period. Here, the first period may be longer than the second period.

That is, when another electronic device is located in the vicinity, the period of receiving information is short. In this case, the information may be updated more quickly and accordingly it is possible to secure information more accurately.

Such a change in the period may be made based on the another electronic device's identifying the distance to the electronic device.

In some cases, information on the electronic device may be transmitted from the electronic device to the another electronic device based on the distance to the another electronic distance. For example, when the electronic device is positioned at the first location 1320, the information on the electronic device may be transmitted in a first period, and, when the electronic device may be positioned at a second location 1320, the information on the electronic device may be transmitted in a second period. Here, the first period may be longer than the second period.

Meanwhile, the distance between the electronic device and the another electronic device may be identified through a variety of sensors included in the electronic device, for example, a radar sensor and a ladar sensor, and a detailed description thereof will be herein omitted since it is apparent to those skilled in the art.

FIG. 14 is a view conceptually illustrating a method for identifying a landing route of an electronic device according to an embodiment of the present disclosure.

Referring to FIG. 14, the electronic device may attempt to land at a second location 1410 from a first location 1420. In this case, it is required to identify the landing route of the electronic device from the first location 1420 to the second location 1410.

Meanwhile, in some cases, wind may blow in the surroundings of the electronic device. In this case, an error 1450 may occur the landing route 1430. That is, due to the wind, the electronic device may not move along the landing route 1430. Instead, the electronic device may move along a route having the predetermined error 1450 (hereinafter, referred to as an erroneous route 1440). This error 1450 may correspond to, for example, a drift angle.

In this case, the landing route may be corrected from a point which is at a predetermined altitude above the second location 1410, that is, a third location 1420, by taking into consideration a component of wind. A processor of the electronic device may correct the landing route using the second position 1410, a speed of the wind, a direction of the wind, a speed of the electronic device, and a distance between the first location 1420 and the second location 1410. For the correction of the landing route, various location correcting technologies may be employed, and a detailed description thereof will be herein omitted since it is apparent to those skilled in the art.

Accordingly, the electronic device may move along the corrected landing route 1460 and land at the second location 1410.

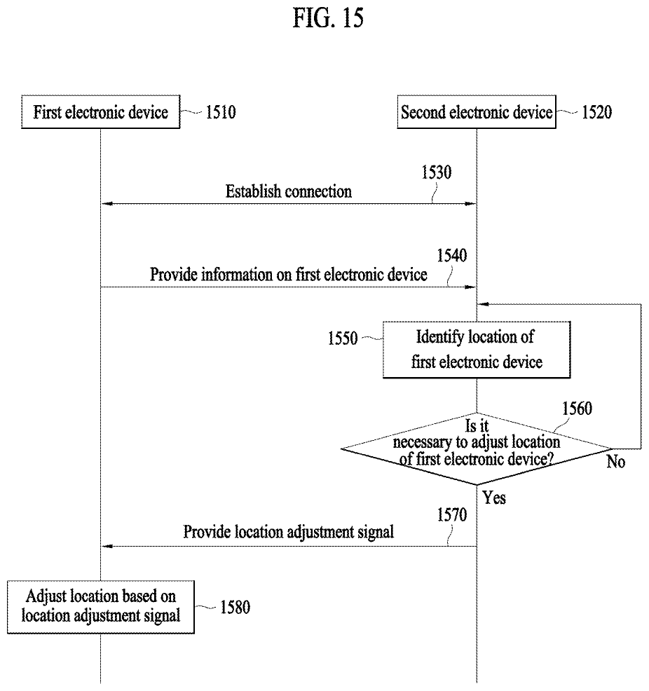

FIG. 15 is a signal flowchart regarding location adjustment of an electronic device according to an embodiment of the present disclosure.

Referring to FIG. 15, connection between a first electronic device 1510 and a second electronic device 1520 may be established in operation 1530. Here, the first electronic device 1510 may correspond to the aforementioned electronic device, and the second electronic device 1520 may correspond to the aforementioned another electronic device.

The first electronic device 1510 may provide information on the first electronic device 1510 (or information regarding the first electronic device 1510) to the second electronic device 1520 in operation 1540. The information on the first electronic device 1510 may be, for example, information on a location (e.g., a latitude, an altitude, a longitude) of the first electronic device 1510.

The second electronic device 1520 may receive information on a first electronic device 1510 from the first electronic device 1510 in operation 1540. Based on the received information, the second electronic device 1520 may identify the location of the first electronic device 1510 in operation 1550.

The second electronic device 1520 may determine whether it is necessary to adjust the location of the first electronic device 1510 in operation 1560. Specifically, the second electronic device 1520 may identify a distance between the first electronic device 1510 and the second electronic device 1520. When the distance between the first electronic device 1510 and the second electronic device 1520 is less than a predetermine value, the second electronic device 1520 may determine that it is necessary to adjust the location of the first electronic device 1510. When the distance between the first electronic device 1510 and the second electronic device 1520 is equal to or greater than the predetermined value, the second electronic device 1520 may determine that it is not necessary to adjust the location of the first electronic device 1510.

When it is necessary to adjust the location of the first electronic device 1510, the second electronic device 1520 may provide a location adjustment signal to the first electronic device 1510 in operation 1570. The location adjustment signal may be a signal for requesting adjustment of a location. For example, the location adjustment signal may be a signal for requesting adjust the location of the first electronic device 1510 so that the distance between the first electronic device 1510 and the second electronic device 1520 becomes equal to or greater than the predetermined value.

When it is not necessary to adjust the location of the first electronic device 1510, the second electronic device 1520 may perform operation 1550 again. However, aspects of the present disclosure are not limited thereof, and the second electronic device 150 may terminate operation regarding location adjustment.

When the first electronic device 1510 receives the location adjustment signal, the first electronic device 1510 may adjust the location thereof based on the location adjustment signal in operation 1580. Specifically, the first electronic device 1510 may adjust the location thereof in correspondence with the received location adjustment signal. For example, when the location adjustment signal is a signal to request increasing the distance between the first electronic device 1510 and the second electronic device 1520 to be equal to or greater than the predetermined value and an altitude of the second electronic device 1520 is lower than an altitude of the first electronic device 1510, the first electronic device 1510 may increase the altitude of the first electronic device 1510.

However, the location adjustment is not limited to altitude adjustment and may be implemented in various ways. For example, the location adjustment may be implemented in a manner of adjusting a latitude or longitude while maintaining an altitude.

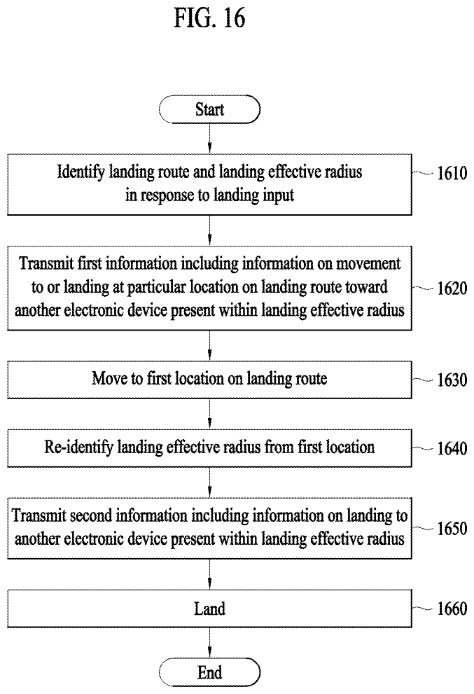

FIG. 16 is a flowchart of landing-related operations in a method for providing flight information according to an embodiment of the present disclosure.

Referring to FIG. 16, an electronic device (or a processor (e.g., the processor 1030 in FIG. 10)) may identify a landing route and a landing effective radius in response to a landing input in operation 1610. Specifically, when a landing input for requesting landing is acquired, the electronic device may identify a landing route from a current location to a landing point and a landing effective radius indicating a predetermined range on the ground, which is predicted as the landing point.

The electronic device may transmit first information, including information on movement to and landing at a particular location on the landing route, to another electronic device present in the landing effective radius.

Specifically, based on information acquired from the another electronic device, the electronic device may determine whether the another electronic device is present in the landing effective radius. When it is determined that the another electronic device is present in the landing effective radius, the electronic device may transmit, to the another electronic device, the information on the movement to and landing to the particular location on the landing route.

The information on the movement to the particular location may include, for example, a particular location which the electronic device passes through before landing (hereinafter, referred to as a first location). The information on the landing may include, for example, information notifying landing start, information on a point in time estimated to land, and information indicating a landing point.

The electronic device may move to the first location on the landing route in operation 1630, and re-identify the landing effective radius from the first location in operation 1640. The electronic device may determine whether the another electronic device is present in the re-identified landing effective radius.

Here, the re-identified landing effective radius may correspond to the landing effective radius identified in operation 1610, but aspects of the present disclosure are not limited thereto and the re-identified landing effective radius may change depending on a situation (e.g., change of wind blowing direction). In addition, the term “another electronic device” of which the presence is determined in operation 1640 is used to be differentiated from the electronic device, and this term may be identical to or different from the term “another electronic device” mentioned in operation 1620.

When the another electronic device is present within the re-identified landing effective radius, the electronic device may transmit second information including information on landing to the another electronic device in operation 1650. In response to receiving the second information, the another electronic device may move out of the landing effective radius.

Here, the information on the landing may include at least one of information indicating that landing is in progress, information on a point in time estimated to land, or a landing point.

When it is determined that the another electronic device is not present in the landing effective radius, the electronic device may land at the landing point in the landing effective radius in operation 1660. Although not illustrated, when the another electronic device is present in the landing effective radius, the electronic device may re-transmit the information on the landing to the another electronic device so as to induce movement of the another electronic device.

Meanwhile, even when the information on the landing described with reference to FIGS. 14 to 16 are performed, a three-dimensional map may be constantly displayed through the electronic device, and a user may more accurately identify the landing point and the information on the another electronic device through the three-dimensional map.

The electronic device and the method thereof according to an embodiment of the present disclosure provide information on a space through a three-dimensional map, thereby enabled to provide more accurate and more effective location information even in a flying situation where it is hard to identify an accurate location, unlike when a two-dimensional map is used.

The electronic device and the method thereof according to an embodiment of the present disclosure effectively provide flight-related information by displaying information on another electronic device on the three-dimensional map including auxiliary lines corresponding to three-dimensional coordinates, thereby improving flight stability and convenience.

However, effects of the present disclosure are not limited to the aforementioned effects, and other effects not mentioned herein may be clearly appreciated by those skilled in the art to which the technical field of the present disclosure pertains.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operations to be performed on the computer or other programmable apparatus to produce a computer implemented process such that the instructions which are executed on the computer or other programmable apparatus provide operations for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

Although exemplary aspects of the present disclosure have been described for illustrative purposes, those skilled in the art will appreciate that various modifications, additions and substitutions are possible, without departing from essential characteristics of the present disclosure. Thus, embodiments disclosed herein are exemplary only and not to be considered as a limitation of the present disclosure. Accordingly, the scope of the present disclosure is not to be limited by the above aspects but by the claims and the equivalents thereof.

What is claimed is:

1. A method for an electronic device, the method comprising:
identifying location information of the electronic device;
displaying a three-dimensional map associated with a location of the electronic device and comprising auxiliary lines corresponding to three-dimensional coordinates;
receiving, from another electronic device, a first message comprising location information of the another electronic device; and
based on the first message and the auxiliary lines, displaying information on the another electronic device on the three-dimensional map,
wherein at least one of the location information of the electronic device or the location information of the another electronic device comprises coordinate information of a matrix corresponding to a three-dimensional space.

2. The method of claim 1, wherein the first message comprises at least one of the following: time information corresponding to transmission of the first message, information on accuracy of the location information, information on a latitude of the another electronic device, information on a longitude of the another electronic device, information on an altitude of the another electronic device, information on a moving speed of the another electronic device, information on a moving direction of the another electronic device, information on a moving state of the another electronic device, information on a size of the another electronic device, information on a previous route of the another electronic device, and information on a predicted route of the another electronic device.

3. The method of claim 1, further comprising:
receiving, from the another electronic device, a second message to request altitude adjustment; and
changing an altitude of the electronic device based on the received second message.

4. The method of claim 1, wherein:
when a distance between the electronic device and the another electronic device satisfies a first condition, the first message is received in a first period, and
when the distance between the electronic device and the another electronic device satisfies a second condition, the first message is received in a second period.

5. The method of claim 4, wherein:
the distance satisfying the first condition is longer than the distance satisfying the second condition, and
the first period is longer than the second period.

6. The method of claim 1, further comprising:
when an altitude of the electronic device is less than a predetermined value, identifying, based on the information on the another electronic device, a landing route that maintains a distance to the another electronic device to be equal to or greater than a predetermined value; and
transmitting information on landing to the another electronic device.

7. The method of claim 6, wherein the identifying of the landing route further comprises identifying the landing route of the electronic device by taking into consideration information on wind blowing in an area where the electronic device is located.

8. The method of claim 1, wherein:
the displaying of the three-dimensional map comprises displaying the three-dimensional map regarding a space within a predetermined distance from the electronic device, and
the predetermined distance is determined based on a flyable altitude.

9. The method of claim 1, wherein:
the three-dimensional map is generated in units of cells each comprised of a width, a length, and a height that are predesignated based on the auxiliary lines,
the cells in the three-dimensional map comprise information on areas corresponding to the respective cells, and
the width, the length, and the height of each of the cells change based on a distance between the electronic device and the another electronic device.

10. An electronic device, comprising:
a transceiver configured to communicate with another electronic device;
a memory configured to store information on a three-dimensional map comprising auxiliary lines corresponding to three-dimensional coordinates; and
at least one processor,
wherein the at least one processor is configured to
identify location information of the electronic device,
display the thee-dimensional map associated with a location of the electronic device,
receive, from the another electronic device a first message comprising location information of the another electronic device, and
based on the first message and the auxiliary lines, display information on the another electronic device on the three-dimensional map, and
wherein at least one of the location information of the electronic device or the location information of the another electronic device comprises coordinate information of a matrix corresponding to a three-dimensional space.

11. The electronic device of claim 10, wherein the first message comprises at least one of the following: time information corresponding to transmission of the first message, information on accuracy of the location information, information on a latitude of the another electronic device, information on a longitude of the another electronic device, information on an altitude of the another electronic device, information on a moving speed of the another electronic device, information on a moving direction of the another electronic device, information on a moving state of the another electronic device, information on a size of the another electronic device, information on a previous route of the another electronic device, and information on a predicted route of the another electronic device.

12. The electronic device of claim 10, wherein the at least one processor is further configured to:
receive, from the another electronic device, a second message to request altitude adjustment; and
change an altitude of the electronic device based on the received second message.

13. The electronic device of claim 10, wherein:
when a distance between the electronic device and the another electronic device satisfies a first condition, the first message is received in a first period, and
when the distance between the electronic device and the another electronic device satisfies a second condition, the first message is received in a second period.

14. The electronic device of claim 13, wherein:
the distance satisfying the first condition is longer than the distance satisfying the second condition, and
the first period is longer than the second period.

15. The electronic device of claim 10, wherein the processor is further configured to:
when an altitude of the electronic device is less than a predetermined value, identify, based on the information on the another electronic device, a landing route that maintains a distance to the another electronic device to be equal to or greater than a predetermined value; and
transmit information on landing to the another electronic device.

16. The electronic device of claim 15, wherein the processor is further configured to identify the landing route of the electronic device by taking into consideration information on wind blowing in an area where the electronic device is located.

17. The electronic device of claim 10, wherein:
the processor is further configured to display the three-dimensional map regarding a space within a predetermined distance from the electronic device, and
the predetermined distance is determined based on a flyable altitude.

18. The electronic device of claim 10, wherein:
the three-dimensional map is generated in units of cells each comprised of a width, a length, and a height that are predesignated based on the auxiliary lines,
the cells in the three-dimensional map comprise information on areas corresponding to the respective cells, and
the width, the length, and the height of each of the cells change based on a distance between the electronic device and the another electronic device.

19. A computer-readable recording medium programed to:
identify location information of the electronic device;
display a three-dimensional map associated with a location of the electronic device and comprising auxiliary lines corresponding to three-dimensional coordinates;
receive, from another electronic device, a first message comprising location information of the another electronic device; and
display information on the another electronic device on the three-dimensional map based on the first message and the auxiliary lines,
wherein at least one of the location information of the electronic device or the location information of the another electronic device comprises coordinate information of a matrix corresponding to a three-dimensional space.
